(19) United States
(12) Patent Application Publication
(10) Pub. No.: US 2026/0158845 A1
(43) Pub. Date: Jun. 11, 2026

(54) FORCE ARBITRATION IN ACTIVE SUSPENSION SYSTEMS

(71) Applicant: ClearMotion, Inc., Billerica, MA (US)

(72) Inventors: Timothy Vernon Light, Tamworth (GB); Frederick Vrancken, Göteborg (SE)

(73) Assignee: ClearMotion, Inc., Billerica, MA (US)

(21) Appl. No.: 19/110,276

(22) PCT Filed: Sep. 11, 2023
(86) PCT No.: PCT/US2023/073898

§ 371 Date: Mar. 10, 2025

Related U.S. Application Data
(60) Provisional application No. 63/405,636, filed on Sep. 12, 2022.

(51) Int. Cl. B60G 17/016

(52) U.S. Cl. CPC B60G 17/016

(57) ABSTRACT

A vehicle may include a chassis, four wheels, and an active suspension system operatively coupled to the four wheels and the chassis, where the active suspension system comprises at least one actuator configured to apply active forces to at least one of the four wheels. A processor may be configured to control the active suspension system by receiving a first force request for force to alter a first motion characteristic of the chassis, allocating a first force allocation to the first force request based on a force capacity, receiving a second force request for force to alter a second motion characteristic of the chassis, allocating a second force allocation to the second force request based on the first force allocation, and commanding the at least one actuator to apply force based on the first force allocation and the second force allocation.

### RELATED APPLICATIONS

This application claims the benefit of priority under 35 U.S.C. § 119(e) of U.S. Provisional Application Ser. No. 63/405,636, filed Sep. 12, 2022, the disclosure of which is incorporated herein by reference in its entirety.

### FIELD

Disclosed embodiments are related to force arbitration in active suspension systems and related methods of use.

### BACKGROUND

Suspension systems are typically designed to properly support and orient a vehicle, provide safe handling in various expected operating environments and ensure a comfortable ride for occupants. Conventional suspension systems are typically passive with largely constant operating and performance parameters. Some suspension systems are semi-active in that their overall response can be adjusted, for example, to offer a trade-off between occupant comfort and vehicle handling. Fully active suspension systems use actuators to react automatically to changing road conditions by relying on input from sensors and other measurement devices.

### SUMMARY

In some embodiments, a method of controlling an active suspension actuator of a vehicle with a force capacity includes: with at least one processor of the actuator, receiving a first force request for force from the active suspension actuator to alter a first motion characteristic of a portion of the vehicle, where the first force request is less than the force capacity of the active suspension actuator; and with the at least one processor, commanding the active suspension actuator to apply a first intervening force between the portion of the vehicle and a wheel assembly of the vehicle, where the first intervening force is less than the first force request.

In some embodiments, a vehicle may include: a chassis; a plurality of wheels; an active suspension system operatively coupled to the plurality of wheels and the chassis, where the active suspension system comprises at least one actuator configured to apply active forces to at least one of the plurality of wheels in at least one mode of operation; and at least one processor configured to perform the above method.

In some embodiments, a vehicle may include a chassis, a plurality of wheels, an active suspension system operatively coupled to the plurality of wheels and the chassis, where the active suspension system comprises at least one actuator configured to apply active forces to at least one of the plurality of wheels in at least one mode of operation, and at least one processor configured to control the active suspension system. The at least one processor is configured to obtain a force capacity of the at least one actuator, receive a first force request for force from the at least one actuator to alter a first motion characteristic of the chassis, allocate a first force allocation to the first force request based at least partly on the force capacity, receive a second force request for force from the at least one actuator to alter a second motion characteristic of the chassis, allocate a second force allocation to the second force request based at least partly on the first force allocation and the force capacity, and command the at least one actuator to apply force between at least one of the plurality of wheels and the chassis based at least partly on the first force allocation and the second force allocation.

In some embodiments, a vehicle may include a chassis, a plurality of wheels, and an active suspension system, where the active suspension system is operatively coupled to the plurality of wheels, and where the active suspension system comprises at least one actuator configured to apply active forces to at least one of the plurality of wheels in at least one mode of operation. A method of controlling the vehicle may include obtaining a force capacity of the at least one actuator, receiving a first force request for force from the at least one actuator to alter a first motion characteristic of the chassis, allocating a first force allocation to the first force request based at least partly on the force capacity, receiving a second force request for force from the at least one actuator to alter a second motion characteristic of the chassis, allocating a second force allocation to the second force request based at least partly on the first force allocation and the force capacity, and commanding the at least one actuator to apply force between at least one of the plurality of wheels and the chassis based at least partly on the first force allocation and the second force allocation.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is a block diagram of one embodiment of a vehicle including a vehicle control system and vehicle outputs for the vehicle control system;

FIG. 2 is a schematic of the vehicle of FIG. 1;

FIG. 3 is a side schematic of a vehicle showing an exemplary set of vehicle motion characteristics;

FIG. 4 is a rear schematic of a vehicle showing another exemplary set of vehicle motion characteristics;

FIG. 5 is a side schematic of a vehicle showing another exemplary set of vehicle motion characteristics;

FIG. 6 is a top schematic of a vehicle showing another exemplary vehicle motion characteristic;

FIG. 7 is a block diagram of one embodiment of a method of controlling a vehicle; and

FIG. 8 is a flow chart for one embodiment of a method of controlling a vehicle.

### DETAILED DESCRIPTION

In conventional vehicles, a vehicle suspension may be responsible for control of a plurality of vehicle motion characteristics. Such vehicle motion characteristics may include, but are not limited to, roll stiffness, roll damping, heave damping, pitch damping, pitch stiffness, and twist stiffness. In some cases, an active suspension may be employed in a vehicle to provide for active control of one or more of these or other vehicle motion characteristics. The plurality of vehicle motion characteristics may be assigned one or more controllers configured to generate an output force to control each of the respective vehicle motion characteristics. In some circumstances, each of one or more active suspension actuators may be limited in the force that it is able to apply to control various vehicle motion characteristics. In such circumstances, it may not be possible to simultaneously control multiple vehicle motion characteristics and the various demands on the capability of an actuator may conflict with one another. The limited force capacity of an active suspension system may not be enough to control all desired vehicle motion characteristics concurrently. Accordingly, the inventors have recognized that active suspension actuators may have inherent force capacity limitations, and multiple competing commands for force from an active suspension system actuator can lead to saturating the available force capacity of the actuator which may be undesirable. Such saturation may lead to the active suspension system not meeting desired performance characteristics for a vehicle chassis due to an inability to provide more force to control one or more additional vehicle motion characteristics. In some cases, force requests for controlling or modifying one vehicle motion characteristic may saturate an active suspension system actuator, leaving no force capacity for controlling other vehicle motion characteristics. In such cases, a vehicle motion characteristic that is less important for vehicle performance may prevent or inhibit control of a vehicle motion characteristic that is more important for vehicle performance or occupant comfort. In some embodiments it may be desirable to prioritize control of certain vehicle motion characteristics over other vehicle motion characteristics when employing one or more actuators having a limited force capacity to achieve a desired overall vehicle performance.

In view of the foregoing, the inventors have recognized the benefits of a vehicle control system that prioritizes control of one or more vehicle motion characteristics over other vehicle motion characteristics. In particular, the inventors have recognized the benefits of a vehicle control system that employs a vehicle motion characteristic hierarchy to arbitrate force requests from an active suspension system where the active suspension has a certain force capacity. In some embodiments, the vehicle motion characteristic hierarchy may, for example, prioritize vehicle dynamics affecting the braking or steering performance of the vehicle over vehicle dynamics affecting user comfort or cornering performance. In some embodiments, the vehicle control system may prioritize vehicle motion characteristics that improve average traction and/or vehicle handling during braking events. Additionally, the vehicle control system may be employed to vehicle motion characteristics that improve traction and handling in circumstances of low road friction (e.g., caused by a road feature or road surface conditions) or otherwise improve handling of a vehicle during certain events (e.g., turns, emergency maneuvers, etc.).

In some cases, a user of a vehicle (e.g., a driver or other vehicle occupant) may provide input to control and/or operate one or more vehicle systems. For example, a user may provide input through a steering wheel to control a steering system of the vehicle. As another example, a user may provide input through one or more pedals to control a throttle, braking system, or transmission of the vehicle. A user may also be able to provide input through one or more buttons, switches, and/or graphical user interfaces to control various parameters of vehicle systems. The inventors have recognized that user input provided through a vehicle user interface plays an important role in the dynamics of a vehicle during many vehicle events, including encountering road features (e.g., potholes, road friction changes, bumps, curves, corners, etc.), turning, and emergency maneuvers. In some instances, user input may prevent power from being allotted to control automated vehicle systems needed to operate the vehicle in a safe manner. For example, a driver may overcorrect during oversteer or may apply brakes during hard turning, actions which may destabilize a vehicle. Accordingly, the effectiveness of vehicle control systems including safety systems like traction controls systems and braking systems may be reduced or negated by incorrect or inappropriate user input during a road event. Additionally, a user may expect a certain response of the vehicle in response to user input. Control systems that do not respond as expected may unsettle a user of the vehicle.

In view of the above, the inventors have recognized the benefits of a vehicle configured to prioritize control of the one or more actuators of an active suspension system that may target vehicle motion characteristics that are perceptible to a user of the vehicle. The inventors have recognized that forces applied by one or more actuators of the active suspension system may be employed to more closely control certain vehicle motion characteristics and to provide a more readily predictable active suspension response for the user of the vehicle. In some embodiments, the active suspension system may also prioritize reducing vehicle motion characteristics that may destabilize the vehicle over vehicle motion characteristics that primarily affect user comfort and/or vehicle cornering performance (e.g., sports performance).

In some embodiments, a vehicle may include a chassis and one or more wheels (e.g., four wheels) supporting the chassis. The vehicle may include an active suspension system operatively interposed between the one or more wheels and the chassis. The active suspension system may be configured to adjust a normal force between a wheel of the vehicle and the ground (e.g., via a tire) by applying force between the wheel and a chassis of the vehicle. The active suspension system may be configured to generate extension or compression of a suspension assembly main spring, in some embodiments. The forces applied between the wheels and the chassis may be transferred to the chassis through the active suspension system, allowing the active suspension system to control one or more motion characteristics of the vehicle chassis. Vehicle motion characteristics, may include, but are not limited to, rotations about various axes (e.g., roll and pitch). Vehicle motion characteristics may also include, but are not limited to, translation along various axes (e.g., translation along a vertical z-axis otherwise referred to as “heave”). In some embodiments, three Cartesian principal axes may be established relative to a supporting surface underneath a vehicle (e.g., a plane). In some embodiments, the three cartesian principal axes may be established relative to a direction of local gravity when the vehicle is disposed on level ground. As discussed further below, the active suspension system may control one or more vehicle motion characteristics of the chassis of the vehicle by applying active or passive forces between the chassis and one or more wheels. Changing the force output by the active suspension system may alter the one or more vehicle motion characteristics. In some embodiments, a vehicle may include at least one processor configured to execute computer readable instructions stored in associated volatile or non-volatile memory. In some embodiments, the at least one processor may be configured to control the active suspension system to control the one or more vehicle motion characteristics of the chassis. In some embodiments, the at least one processor may operate as a part of one or more controllers of the vehicle.

In some embodiments, an active suspension system is operatively interposed between one or more wheels and a chassis of a vehicle. The active suspension system may include one or more actuators associated with the one or more wheels. For example, the active suspension system may include one actuator associated with each wheel of the vehicle. In some embodiments, an actuator of an active suspension system may be electro-hydraulic device that comprises a hydraulic motor/pump and/or an electric motor/generator. The term hydraulic motor/pump may refer to either a hydraulic motor, a hydraulic pump, a hydraulic motor being operated as a pump, or a hydraulic pump being operated as a hydraulic motor. A hydraulic motor/pump may be capable of providing fixed displacements, variable displacements, fixed velocities, and/or variable velocities as the disclosure is not limited to any particular type of device. Appropriate types of hydraulic motor/pumps may include, but are not limited to, gerotor pumps, vane pumps, gear pumps, screw pumps, and/or any other appropriate type of hydraulic device. The term electric motor/generator may refer to either an electric motor and/or an electric generator. In either case, in some embodiments, an associated hydraulic device may drive the electric motor/generator such that it functions as a generator to provide damping to a hydraulic actuator while also generating electrical energy. The electric motor/generator may also drive the hydraulic device as a pump to create a flow of fluid to drive operation of the actuator and/or resist movement of a piston of the actuator. Depending on the particular embodiment, an electric motor/generator may be operated only as a generator, only as a driven motor, and/or as both depending on the particular application. Appropriate types of electric motor/generators may include, but are not limited to, a brushless DC motor, a brushed DC motor, an induction motor, a dynamo, or any other type of device capable of converting electricity into rotary motion and/or vice-versa. The actuator may be configured to apply active and/or passive forces between a wheel of the vehicle and the chassis of the vehicle. The application of active and/or passive forces may be employed to control a motion of the chassis and/or wheel. In some embodiments, an active suspension system may include one or more physical springs or dampers, which may apply passive forces to the one or more wheels and the chassis of the vehicle.

In some embodiments, an actuator of an active suspension system may have a particular maximum operating force capacity and or a maximum displacement capacity. The force capacity may be an amount of force the actuator is able to produce, under certain operating or environmental conditions (e.g., ambient temperature), which has a finite value. The displacement capacity may be an amount of displacement the actuator is able to produce, under certain operating or environmental conditions (e.g., ambient temperature), which has a finite value. In some embodiments, the force capacity and or the displacement capacity may be based on the physical configuration of the actuator and the material limits of that configuration, if any, and accordingly may be a design force and or displacement capacity. In some embodiments, the force and/or displacement capacity may be based on the limits of the actuator with an additional safety factor. In some embodiments, the force capacity may set as a limit in software. In some embodiments, a particular actuator may have a force capacity and/or displacement capacity may be based on other physical characteristics of the vehicle and/or actuators, such as vehicle weight, type, actuator design, etc. For example, a vehicle with a greater weight may have an active suspension with a greater force capacity than a vehicle with a lower weight. The force capacity and/or displacement capacity may affect the ability of the active suspension system to control one or more vehicle motion characteristics. For example, if the force capacity and/or displacement capacity of an actuator is saturated and more force or displacement is required to control the vehicle chassis as desired, then the actuator may not be capable of providing the desired additional force and/or displacement. In this manner, the force capacity and/or displacement capacity of an actuator may be allocated according to exemplary embodiments herein to prioritize certain vehicle motion characteristics which may be considered more important over other vehicle motion characteristics which may be considered less important. In the remainder of the disclosure, the discussion will focus on the allocation of actuator force capacity to the control of various vehicle motion characteristics. It is noted, however, that actuator displacement may be similarly allocated.

In some embodiments, a vehicle may employ an actuator having a force capacity based on the mass of the vehicle (e.g., vehicle mass based on gross vehicle weight rating). In some embodiments, a ratio between the force capacity of an actuator and a vehicle mass may be greater than or equal to 0.4 N/kg, 1.0 N/kg, 2.0 N/kg, and/or any other appropriate ratio. In some embodiments, a ratio between the force capacity of an actuator and a vehicle mass may be less than or equal to 2.5 N/kg, 1.5 N/kg, 1.0 N/kg, and/or any other appropriate ratio. Combinations of the above-noted ranges are contemplated, including ratios between 0.4 and 2.5 N/kg, 1.0 and 1.5 N/kg, and 1.0 and 2.5 N/kg. In some embodiments, a ratio between the force capacity of an actuator and vehicle mass may be measured at the wheel of a vehicle, where any lever arm effects have been accounted for, e.g. when an actuator is placed inboard of the wheel. Any suitable ratio may be employed in some embodiments, as the present disclosure is not so limited. In some embodiments, any suitable force capacity may be employed in an actuator, as the present disclosure is not so limited.

In some embodiments, a method of operating a vehicle includes obtaining or determining a force capacity of at least one actuator of a vehicle. The at least one actuator may include four actuators, each associated with a single wheel of a vehicle, in some embodiments. In some embodiments, the force capacity may be an average force capacity of each individual actuator of the at least one actuator. In some embodiments, the force capacity may be a total force capacity (e.g., a sum) of individual force capacities for each individual actuator of the at least one actuator. The method may also include receiving a first force request for force from the at least one actuator to alter a first motion characteristic of the chassis. In some embodiments, the first force request may be received from a controller associated with the first motion characteristics (e.g., via a communications network). The method may include allocating a first force allocation to the first force request based on the force capacity of the at least one actuator. In some embodiments, the allocation to the first force request may be less than or equal to the force capacity, such that the allocation is limited to the force capacity. In some embodiments, the allocation may be less than the force capacity, such that force may be allocated to other force requests. The method may also include receiving a second force request for force from the at least one actuator to alter a second motion characteristic of the chassis. The second motion characteristic may be different than the first motion characteristic. For example, the first vehicle motion characteristic may be roll stiffness of the chassis and the second motion characteristics may be roll damping of the chassis. The method may include allocating a second force allocation to the second force request based at least partly on the first force allocation and the force capacity. For example, a sum of the first force allocation and the second force allocation may not exceed the force capacity. In some embodiments, the second force allocation may be a difference between the first force allocation and the force capacity of the at least one actuator. In this manner, force may be allocated primarily to the first force request as a higher priority than the second force request. The method may include commanding the at least one actuator to apply force between the at least one wheel and the chassis based at least partly on the first force allocation and the second force allocation. The method may include applying the force with the actuator according to the first and second force allocations to control the first vehicle motion characteristic and the second vehicle motion characteristic. In some embodiments, the method described above may be performed by at least one processor of the vehicle (e.g., executing computer readable instructions formed in non-volatile memory).

In some embodiments, allocating force in response to a force request may be based at least partly on a force allocation limit that is less than a force capacity of an actuator. Such a force allocation limit may be beneficial to ensure that the entire force capacity of an actuator is not consumed to the control of a single vehicle motion characteristic. While the inventors have recognized that certain vehicle motion characteristics may have a higher priority than the control of other characteristics, the inventors have recognized it may be desirable to reserve some of the force capacity for the control of lower priority vehicle motion characteristics as well. Such an arrangement may be desirable in the case of transient spikes in force requests, which may be in response to encountering a road event (e.g., a pothole, bump, etc.). As a force allocation may be limited for a particular vehicle motion characteristic, control of that one vehicle motion characteristic may not prevent control of other lower priority vehicle motion characteristics. In some embodiments, a force allocation limit may be a percentage of an actuator force capacity greater than zero. For example, in some embodiments a force allocation limit may be 60% of a force capacity, 70% of a force capacity, 75% of a force capacity, 80% of a force capacity, 90% of a force capacity, or another suitable percentage. In some embodiments in addition to the force allocation limit there may be a lower force allocation limit which may be for example 1% of the force capacity of the actuator. In some embodiments, for example, the force allocation limit may be between a lower allocation limit of 1% and an allocation limit of 75% of a force capacity of an actuator. It should be understood that any appropriate force allocation limit may be selected for an actuator as the disclosure is not so limited.

As used herein an “active force” is a force that is generated by a vehicle system and applied to a wheel or wheel assembly in the direction of motion of the point of application of the force. For example, an active force may include applying force to a wheel or wheel assembly in the direction of the motion of the wheel via an active suspension system actuator. An active force or a component of an active force may be oriented in a direction of motion of the point of the application of the force with the actuator. As used herein a “passive force” is a force that may be applied on a component in a direction that opposes the motion of the point of application of the force. For example, a suspension system spring (e.g., coil spring, air spring, etc.) may generate spring force in response to a wheel being moved by a road feature (e.g., a bump, curve, etc.). As another example, a suspension system damper may generate a passive damping force (e.g., forces that resist movement of a wheel and/or vehicle body) in response to a wheel being moved by a road feature, though it is noted that an active suspension system may also apply damping forces that resist motion of an associated mass. For example, in some embodiments an actuator may apply a damping force in a direction opposite a direction of motion of the component being damped. According to exemplary embodiments described herein, certain vehicle systems (e.g., active suspension systems) may apply active and/or passive forces depending on a mode of operation of the vehicle system and commands received from a controller. For example, an active suspension system may be operated in a first mode where an actuator is employed to apply active forces to the vehicle or a portion of the vehicle and in a second mode where only passive forces are applied in response to external force inputs on the vehicle or a portion of the vehicle. In some operational modes, vehicle systems, including active suspension systems, may generate both active and passive forces.

As discussed herein, a vehicle motion characteristic may refer to motion response of the vehicle chassis that is controlled in a degree of freedom about or along an axis. A vehicle motion characteristic may be represented as a spring or damper of the vehicle chassis about the particular degree of freedom. In some embodiments, a vehicle chassis may have two vehicle motion characteristics (e.g., stiffness and damping) for each degree of freedom. A degree of freedom of a vehicle chassis may include, but is not limited to, roll (e.g., rotation of the vehicle about a longitudinal axis, of the vehicle, in a direction of travel of the vehicle), pitch (e.g., rotation of the vehicle about a transverse axis, of the vehicle, perpendicular to a direction of travel of the vehicle), heave (e.g., translation along a vertical axis of the vehicle), and twist (e.g., torsion about a longitudinal axis of the vehicle in a direction of travel of the vehicle). Vehicle motion characteristics may include, but are not limited to roll stiffness, roll damping, heave damping, pitch damping, pitch stiffness, and twist stiffness. In some embodiments, any suitable vehicle motion characteristics may be controlled, as the present disclosure is not so limited. The inventors have recognized that certain vehicle motions characteristics may be more important, under certain operating conditions, for the performance (e.g. handling or safety) of a vehicle and/or user perception of vehicle performance. Accordingly, the inventors have recognized that since an actuator may have a limited force capacity, it may be desirable to prioritize certain vehicle motion characteristics over others, as discussed further with reference to exemplary methods below.

In some embodiments, exemplary vehicle motion characteristics may be affected and changed by the application of active or passive forces by an active suspension system (e.g., by one or more actuators). For example, roll stiffness may be affected by the application of an appropriate active roll force to enhance vehicle roll stiffness during periods of lateral acceleration of the vehicle. As another example, roll damping may be affected by the application of an appropriate active roll force to enhance vehicle roll damping during transient roll events. As yet another example, heave damping may be affected by the application of an appropriate active heave force to enhance vehicle heave damping during transient heave events. As yet another example, pitch damping may be affected by the application of an active pitch force to enhance vehicle pitch damping during transient pitch events. As yet another example, pitch stiffness may be affected by the application of an appropriate active pitch force to enhance vehicle pitch stiffness during periods of longitudinal acceleration. As yet another example, twist stiffness may be affected by the application of an appropriate active a twist force to dynamically shift roll moment between axles in sport mode. In some embodiments, two or more of the above-noted vehicle motion characteristics may be controlled in a vehicle with an active suspension system. In some embodiments, one or more vehicle motion characteristics, such As for example those indicated above, may be excluded from vehicle control, as the present disclosure is not so limited.

While in some embodiments herein two vehicle motion characteristics are discussed in connection with two force allocations, it should be understood that any number of force allocations may be utilized as a part of a method of operating a vehicle. For example, three, four, five, or six vehicle motion characteristics may have distinct hierarchical force allocations based on a force capacity of an actuator as well as other parameters such as the operating mode or condition of the vehicle, the state of the vehicle, or the state of the actuator in question. In some embodiments, more than six vehicle motion characteristics may be controlled with an active suspension system. In some embodiments, vehicle motion characteristics may be organized in one or more priority groupings. For example, a vehicle handling group at a certain level in a hierarchy may include roll stiffness and roll damping. As another example, a comfort group may include heave-damping and pitch-damping which may be at a different level in the hierarchy. As yet another example, a sports performance group may include pitch stiffness and twist stiffness. In some embodiments, such groups of priority may be employed in exemplary embodiments herein to allocate force to various vehicle motion characteristics. For example, in some embodiments, force may be allocated first to the vehicle handling group, second to the comfort group, and third to the sports performance group. Such a hierarchy has been recognized by the inventors to provide improved perception of vehicle performance for a user of the vehicle. In other embodiments, any group and any priority may be employed to provide a desired chassis response when controlling chassis motion with one or more actuators having a limited force capacity.

In some embodiments, the inventors have recognized that in some cases different vehicle motion characteristics may be prioritized equally. For example, the inventors have recognized that it may not be desirable to allocate force to a particular vehicle motion characteristics before allocating force to another particular vehicle motion characteristic. In some such embodiments, force may be allocated to a combination of a first vehicle motion characteristic and a second vehicle motion characteristic. For example, a method of operating a vehicle may include determining a shared force allocation based on a force capacity of an actuator and any prior force allocations. Based on the shared force allocation, separate force allocations may be determined based on weighting factors assigned to each of the vehicle motion characteristics. In some embodiments, the weighting factors may be equal, such that the shared force allocation is divided equally between the vehicle motion characteristics associated with the shared force allocation. In some embodiments, the weighting factors may be different such that vehicle motion characteristics associated with the shared force allocation receive a predetermined share of the shared force allocation. For example, in some embodiments where two vehicle motion characteristics share a shared force allocation with unequal weightings, a first weighting factor may be between 51 and 99%, and a second weighting factor may be between 1 and 49%. The weighting factors may be determined during manufacture or tuning of a vehicle or received as user input from a user input device, and may be based on a desired vehicle response and the vehicle weight, type, etc. It should be noted that the force allocation formula they also depend on the state of the vehicle (e.g. the vehicle speed) or its operating conditions (e.g. the weather or road surface conditions).

In some embodiments, a method of controlling a vehicle according to exemplary embodiments herein may include allocating force to individual actuators of a vehicle active suspension system based on an individual force capacity of each individual actuator. Accordingly, depending on the actuator and the vehicle motion characteristics to be controlled, force may be allocated differently to achieve a targeted chassis response. Different vehicle actuators may cooperate to control the vehicle motion characteristics of the chassis. In some embodiments, depending on the particular actuator, different force allocation limits may be set for different vehicle motion characteristics. In some embodiments, the different force allocation limits may be based on whether an actuator is a front wheel actuator or a rear wheel actuator. For example, in some embodiments a force allocation limit for a front actuator, for an exemplary motion characteristic, may be 55% of a force capacity, whereas a rear wheel actuator may have a force allocation limit of 45% of a force capacity. Similarly, different force allocation limits may be based on whether an actuator is a left-side actuator or a right-side actuator. In other embodiments, a force capacity may be approximately, effectively equal, or equal for all wheels of a vehicle. Any suitable force allocation limits may be set for an individual actuator within a vehicle, as the present disclosure is not so limited.

In addition to the above, the inventors have recognized the benefits of a method of controlling a vehicle that avoids rapid or excessive cyclic shifting of force allocations. For example, where force allocations are determined cyclically at a predetermined frequency, transient changes in sensor feedback when vehicle encounters a transient event may cause force requests for certain vehicle motion characteristics to rapidly increase. Accordingly, the inventors have recognized that delaying the availability of force allocation to a particular vehicle motion characteristic may be desirable. In some embodiments, a method of operating a vehicle may include detecting a trend of an increased force request across a threshold period of time. According to such embodiments, detecting a positive trend in force requests over the threshold period of time may trigger the increase of a rising hold limit to the vehicle motion characteristic, where the force allocation may not exceed the rising hold limit. In some embodiments, the rising hold limit may be increased at a rate based on a force capacity of the actuator in a manner that allows full utilization of an actuator for vehicle motion characteristic control while suppressing undesirable cyclic shifting of force allocations. In some embodiments, a rate of increase of the rising hold limit may be between 25% and 100% of the force capacity of the actuator per second. In some embodiments, a threshold time period for detection of the trend of increased force request may be between 100 and 500 ms. Other rates and threshold time periods are contemplated, as the present disclosure is not so limited.

In some embodiments, the inventors have recognized the benefits of a return rate limiter to smooth the reduction of a rising hold limit. Such an arrangement may ensure that force capacity is still available to a vehicle motion characteristic during transient declines in a force request associated with a given vehicle motion characteristic. Accordingly, force may be allocated according to the increased rising hold limit rather than immediately resetting to the original, lower rising hold limit. In some embodiments, a return rate limiter may be based on a capacity of an actuator. For example, a rising hold limit may decrease at a rate between 25% and 50% of a force capacity of an actuator per second. In some embodiments, the rising hold limit may not decrease until a threshold period of time has passed with force requests being less than the rising hold limit. In some embodiments, such a threshold period of time for the rising hold limit to begin to decline is between 100 and 500 ms. Any suitable rate and/or threshold period of time to begin rising hold limit decline may be employed, as the present disclosure is not so limited.

While embodiments herein described methods of operating a vehicle including an active suspension, techniques and methods described herein may be applicable to other vehicle systems operating independently or cooperating with an active suspension system. For example, a braking system of a vehicle may allocate force to affect different vehicle motion characteristics. As another example, a crash protection system may receive force allocations for the posturing of a vehicle chassis for imminent impact. Any suitable vehicle system may allocate force according to a predetermined hierarchy, which may be a function of the vehicles operating condition, the vehicle state, or the vehicle environment, to control various vehicle motion characteristics, as the present disclosure is not so limited. In this regard, methods herein are not limited solely to active suspension systems, and in some embodiments may be employed in vehicles having no active suspension system.

As used herein, a “road event” is any event that may occur while a vehicle is traveling on a roadway. In some embodiments, a road event may include encountering a road feature. A “road feature” is any non-nominal road condition that may be encountered by a vehicle while traveling on a road surface. For example, a road feature may include, but is not limited to rough pavement, potholes, manhole covers, bumps, uneven surface, variable road materials (e.g., dirt, gravel, pavement, concrete, metal, etc.), road coverings (e.g., snow, ice, salt, sand, dirt, water, etc.), and/or any other feature that may involve changes in the forces applied to a vehicle encountering or interacting with the feature, e.g., with a wheel of the vehicle going over the feature period. In some embodiments, a road event may include a turn (e.g., traversing a corner). In some embodiments, a road event may include a braking event. A braking event is any instance or period of time in which one or more brakes of a vehicle are applied, e.g., to decelerate or stop the vehicle or the vehicle is decelerated by applying a drag to one or more rotating components in the drive. A braking event may have any duration, as the present disclosure is not so limited. In some embodiments, a braking event may include a single application of the brakes or multiple applications of the brakes, as the present disclosure is not so limited.

In some embodiments, a vehicle may use force from an active suspension system, for example arranged in the twist arrangement such that a vertical upward force is applied to two wheels on opposite corners of the vehicle and a vertical downward force is applied to the two remaining wheels effectively simultaneously, to alter the longitudinal forces on the vehicle in a way that may mitigate undesired yaw behavior of the vehicle even under general braking situations. As an example, road crown or rutting can sometimes create a lateral pull during a braking event, and the active suspension may be used to apply a twist force to mitigate the effect. This mitigation may occur in two forms—either it may mitigate the effect and attempt to reduce metrics such as mentioned above, for example peak yaw rate or peak lateral deviation from the desired path, but it may also try to counteract the perceived behavior, for example, by countering the steering torque created during such a scenario.

According to exemplary embodiments described herein, active suspension systems are suspension systems that can, at least temporarily, vary the normal force exerted on at least one wheel (and tire) of the vehicle by creating an intervening force between the sprung and unsprung mass that includes the wheel. In some embodiments, an active suspension system may include linear or rotary actuators that are hydraulic, electromagnetic, electromechanical, or hydroelectric. In some embodiments, an active suspension system may include electric or hydraulic active roll control actuators. In some embodiments, an active suspension system may include electrically controlled valves. Of course, an active suspension system may include any suitable actuators, springs, and/or dampers to adjust a normal force applied to a wheel and tire of a vehicle, as the present disclosure is not so limited. In some embodiments, an active suspension may have a rapid response time and the ability to produce dynamic responses to an input. Depending on the embodiment, the response time may be less than 50 milliseconds, less than 25 milliseconds or less than 10 milliseconds to a command for a step change in applied vertical force (e.g., to the vehicle body), where the response time is defined as the delay between a command for a step change and reaching 90% of the steady state output. Embodiments disclosed herein provide such capability. In addition, the present active suspension system can exploit the multiple degrees of freedom on a vehicle by using multiple actuators in a coordinated fashion. In some embodiments, active suspension system responses can be vectored normal to the road to produce instantaneous or short duration (e.g., approximately half the period of the natural frequency of the vehicle body on the main suspension springs) changes in wheel force tailored and timed precisely to the vehicle state parameter information the suspension system determines or receives from other vehicle subsystems (e.g., rear steering system, electronic braking system, steering system, etc.).

According to exemplary embodiments described herein, a vehicle control system may be operated by one or more processors. The one or more processors may be configured to execute computer readable instructions stored in volatile or non-volatile memory. The one or more processors may communicate with one or more actuators associated with various elements of the vehicle (e.g., braking system, active suspension system, steering system, rear steering system, driver assistance system, etc.) to control activation and movement of the various elements of the vehicle. The one or more processors may receive information from one or more sensors that provide feedback regarding the various elements of the vehicle. For example, the one or more processors may receive position information regarding the vehicle from a Global Navigation Satellite System (GNSS) or other positioning system. The sensors on board the vehicle may include, but are not limited to, wheel rotation speed sensors, inertial measurement units (IMUs), optical sensors (e.g., cameras, LIDAR), radar, suspension position sensors, gyroscopes, etc. In this manner, the vehicle control system may implement proportional control, integral control, derivative control, a combination thereof (e.g., PID control), or other control strategies of various elements of the vehicle. Other feedback or feedforward control schemes are also contemplated, and the present disclosure is not limited in this regard. Any suitable sensors in any desirable quantities may be employed to provide feedback information to the one or more processors. Information from sensors may be employed in coordination with desirable processing techniques (e.g., machine vision). The one or more processors may also communicate with other controllers, computers, and/or processors on a local area network, wide area network, or internet using an appropriate wireless or wired communication protocol. It should be noted that while exemplary embodiments described herein are described with reference to a single processor, any suitable number of processors may be employed as a part of a vehicle, as the present disclosure is not so limited.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

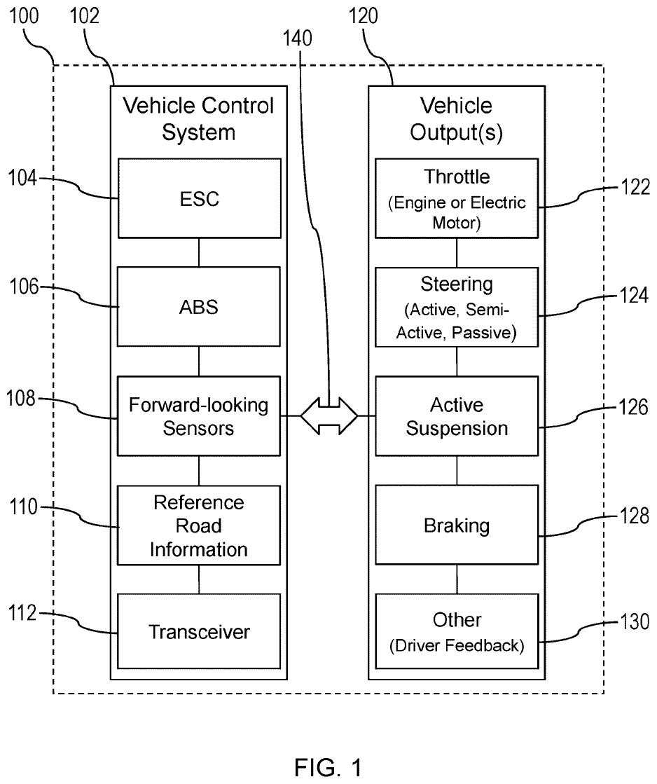

FIG. 1 is an exemplary block diagram of one embodiment of a vehicle 100 including a vehicle control system 102 and vehicle outputs 120 for the vehicle control system. The vehicle control system may include at least one processor configured to execute computer readable instructions and control the vehicle outputs 120. As shown in FIG. 1, the vehicle control system may include an electronic stability control system 104, and anti-lock braking system (ABS 106). The electronic stability control system may be configured to automatically apply the brakes to help steer the vehicle where the driver intends to go when there is a loss of traction. The ABS is configured to inhibit wheels from locking up and sliding. As shown in FIG. 1, the vehicle control system may also include a forward-looking sensor 108. The forward-looking sensor may sense road characteristics, road features, or objects in front the vehicle, which may be provided to the at least one processor as forward-looking road information. In the embodiment of FIG. 1, the vehicle control system may also include reference road information 110 that may be stored in memory onboard the vehicle control system. In some embodiments as shown in FIG. 1, the vehicle control system may also include a transceiver 112 configured to send or receive information. In some embodiments, the transceiver 112 may be configured to receive the reference road information from another vehicle or cloud service (e.g., one or more servers). The transceiver may be configured to communicate wirelessly via any suitable wireless protocol, as the present disclosure is not so limited.

As shown in FIG. 1, the vehicle may include a plurality of vehicle outputs 120 which are controlled by the vehicle control system. In particular, the vehicle outputs may include a throttle 122 (which may include, e.g., the throttle of an engine or electric motor), steering system 124 (which may include, e.g., active steering, semi-active steering, passive steering and/or rear steering), active suspension system 126, braking system 128, and other outputs 130 such as driver feedback. The vehicle control system may be configured to control these vehicle outputs individually or in various combinations. By controlling the various vehicle outputs in combination, the vehicle control system may provide enhanced stability compared to a vehicle with independent control of each system. In some embodiments, the vehicle control system may prioritize certain outputs. For example, the braking system may be prioritized over steering or the active suspension system. In this manner, the more important systems for a given scenario may be prioritized for control, with the possible assistance of other vehicle outputs. In some embodiments, certain outputs may be further prioritized to control for certain vehicle motion characteristics. In this manner, outputs of vehicle system may be employed to provide vehicle motion characteristic control for the highest priority vehicle motion characteristics before allocating outputs to lower priority vehicle motion characteristics. Exemplary operational modes and control schemes for the vehicle outputs are discussed further below.

In some embodiments as shown in FIG. 1, the vehicle may include a real-time bi-directional communication system 140 that enables communication between the various subsystems and vehicle outputs. The communication system may employ any appropriate connection protocol including, for example, a controller area network (CAN), a local interconnect network (LIN), a vehicle area network (VAN), FlexRay, D2B, Ethernet, a direct communication link (such as wires and optical fibers), or a wireless communication link. The communications system may be employed to share information between subsystems, like ABS or ESC, while receiving vehicle state parameters or other information from these same or other systems. Information that may be shared between subsystems and employed for vehicle output control includes, but is not limited to, for example, vehicle yaw and yaw rate, vehicle velocity, vehicle acceleration, vehicle lateral acceleration, steering wheel position, steering wheel torque, if the brakes are being applied, and suspension spring compression. The vehicle control system may control the active suspension system 126 based on information from the vehicle such as the state of one or more vehicle subsystems, such as ABS 106 and ESC 104, that engage during unusual events. For example, the system may provide different control of the wheels and vehicle if one or more systems are engaged.

In addition to the above, in some embodiments an active suspension system 126 may sense several parameters relating to the road, wheel, vehicle body movement, and other parameters that may benefit other vehicle subsystems. Such information may be transmitted from the active suspension system to the other subsystems via the communication system 140. Other vehicle subsystems may alter their control based on information from the active suspension system. As such, bidirectional information may be communicated between the active safety suspension system and other subsystems, and control of both the active suspension system and the other vehicle systems may be provided based at least partially on this information transfer. For example, the application of the brakes of the braking system 128 by the ABS 106 may be synchronized with an increase of wheel force by the active suspension system for one or more wheels. As another example, application of steering with the steering system 124 may be synchronized with an increase of wheel force by the active suspension system for one or more wheels.

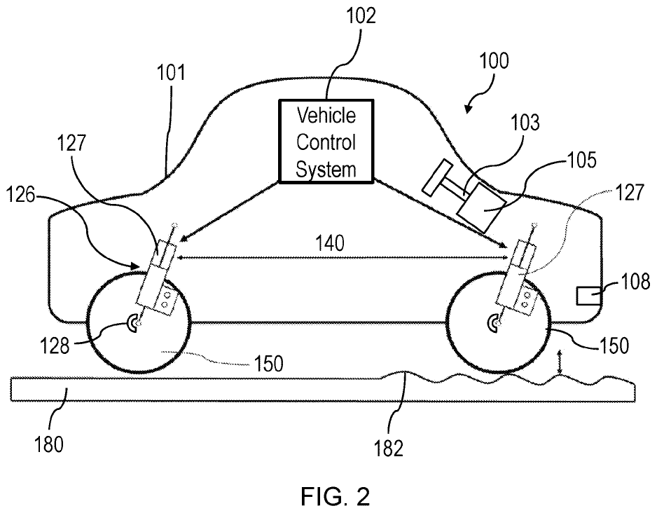

FIG. 2 is a schematic of the vehicle 100 of FIG. 1. The vehicle includes a chassis 101 that supports the various components of the vehicle. As shown in FIG. 2, the vehicle includes a vehicle control system 102 that may communicate with various subsystems via a communication system 140. As shown in FIG. 2, the vehicle includes an active suspension system 126 that is operatively interposed between the wheels 150 (or the wheel assembly, of an unsprung mass) of the vehicle and the chassis 101 (e.g., sprung mass). In particular, active suspension actuators 127 may be operatively interposed between each wheel of the vehicle and the vehicle body, such that separate actuators of the active suspension may independently control the vertical motion of separate wheels of the vehicle. The actuator 127 may be configured to apply force between the wheels 150 and the chassis 101 to adjust a normal component of force between the wheels and a road 180 by applying an active extension or compression force to the wheels 150 relative to the chassis 101. Such an application of force by the actuators 127 may affect a motion response of the chassis 101, and in particular one or more vehicle motion characteristics. The vehicle may also include a braking system 128. The braking system may include independent brakes coupled to each of the vehicle wheels 150, such that a braking force may be applied to each wheel independently. According to the embodiment of FIG. 2, the vehicle may also include a forward-looking sensor 108. The forward-looking sensor 108 may be at least one camera, LIDAR, radar, a combination thereof, or other sensor that may be configured to sense forward-looking road information that may be employed by the vehicle control system 102. Alternatively or additionally forward-looking road information may be received add control system 120 via the communication system.

According to the embodiment of FIG. 2, the vehicle may also include a steering system 105 including, in the case of a driven vehicle, a steering wheel 103. The steering wheel 103 may form a part of a user interface of the vehicle 100. The user interface may be used to provide user input to the vehicle control system and to control various portions of the vehicle. In some embodiments, the user interface may be employed to provide feedback to a user. In some embodiments, the steering system 105 includes a rear steering system configured to control one or more rear wheels of the vehicle. Though other user interfaces and inputs may also be used as described previously. In some cases as discussed above, a user may expect a certain chassis motion response from input applied to the steering wheel 103 and/or other user interfaces. Accordingly, methods of operating a vehicle according to exemplary embodiments herein may include allocating force to the actuators 127 of the active suspension system 126, or other actuators in the vehicle, to prioritize vehicle motion characteristics that align with this expected chassis motion response.

As shown in FIG. 2, the vehicle may traverse over a road 180. The road surface may include one or more road features 182. The road features 182 may cause fluctuations in the normal load of a wheel 150 of the vehicle (e.g., by accelerating the wheel upward and/or downward). In some embodiments, a road feature may produce a chassis motion response of the vehicle based on one or more vehicle motion characteristics of the chassis. For example, a road feature 182 may introduce a roll motion, pitch motion, heave motion, or torsional motion in the vehicle chassis 101 that may be perceptible by a user of the vehicle 100. The vehicle control system 102 may control the active suspension system 126 and the force applied by each of the actuators 127 to provide desired vehicle motion characteristics in response to the disturbance caused by the road feature 182. As discussed further below, force may be allocated to achieve desired vehicle motion characteristics in an order of priority based on the vehicle motion characteristic.

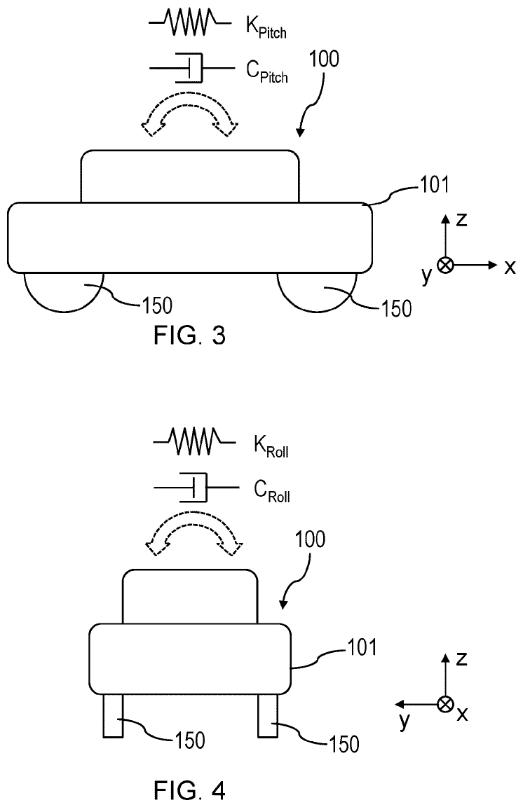

FIGS. 3-6 depict schematics of a vehicle showing exemplary vehicle motion characteristics that may be controlled with an active suspension system of the vehicle. The vehicle motion characteristics may be controlled through the application of one or more forces with one or more active suspension actuators of an active suspension system, which may influence the vehicle motion characteristic as appropriate for the desired response of the chassis to a disturbance. As discussed further below, the one or more actuators of an active suspension system may have a limited force capacity, such that not all of the vehicle motion characteristics may be controlled, as desired, at the same time in certain circumstances (e.g., encountering a certain road feature or road event). Accordingly, in some embodiments vehicle motion characteristics may be prioritized for force allocation based on their importance to the handling of the vehicle as well as user perception of that handling.

FIG. 3 is a side schematic of a vehicle 100 showing a first exemplary set of vehicle motion characteristics. The vehicle includes a chassis 101 operatively coupled to a plurality of wheels 150 (e.g., four wheels). According to the embodiment of FIG. 3, the vehicle has a longitudinal axis (e.g., aligned with a direction of travel) that is parallel to the x-axis. A vehicle pitch may be a rotation of the vehicle about a transverse axis that is perpendicular to the longitudinal axis (e.g., parallel to the y axis), as shown by the dashed arrow. A first vehicle motion characteristic may be pitch stiffness, K_{Pitch}, which represents a stiffness of the vehicle chassis 101 during a pitch motion. A second vehicle motion characteristic may be pitch damping, C_{Pitch}, which represents a damping of the vehicle chassis 101 during a pitch motion. Pitch stiffness and pitch damping may be affected by the application of forces with one or more actuators of an active suspension system. For example, forces countering or assisting the pitch motion of the chassis 101 may damp or aid the pitch motion, affecting the pitch damping. Pitch stiffness may be associated with, for example, sports performance of a vehicle (e.g., during braking events). Pitch damping may be associated with user comfort. In some embodiments, for example, pitch damping may be prioritized during force allocation over pitch stiffness.

FIG. 4 is a rear schematic of a vehicle 100 showing a second exemplary set of vehicle motion characteristics. The vehicle includes a chassis 101 operatively coupled to a plurality of wheels 150 (e.g., four wheels). According to the embodiment of FIG. 4, the vehicle has a longitudinal axis (e.g., aligned with a direction of travel) that is parallel to the x-axis. A vehicle roll may be a rotation of the vehicle about the longitudinal axis, as shown by the dashed arrow. A first vehicle motion characteristic, of the second set of characteristics, may be roll stiffness, K_{Roll}, which represents a stiffness of the vehicle chassis 101 during roll motions. A second vehicle motion characteristic may be roll damping, C_{Roll}, which represents a damping of the vehicle chassis 101 during roll motions. Roll stiffness and roll damping may be influenced by the application of forces with one or more actuators of an active suspension system. For example, damping forces countering the roll motion of the chassis 101 may damp the roll motion, affecting the roll damping. Roll damping and roll stiffness may be associated with a vehicle handling group. The inventors have recognized that in some circumstances roll damping and/or roll stiffness may be the most important vehicle motion characteristics for control during force allocation. In some embodiments, roll stiffness may be prioritized for force allocation over roll damping. In some embodiments, roll stiffness and roll damping may, e.g., be prioritized for force allocation over all other vehicle motion characteristics.

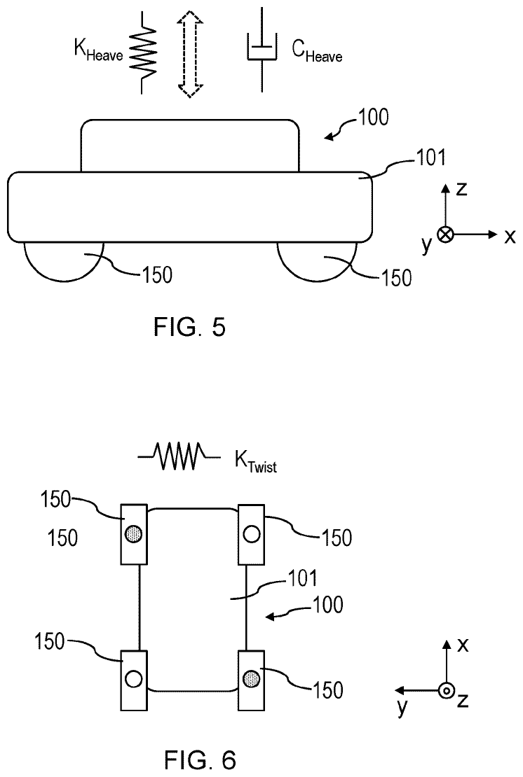

FIG. 5 is a side schematic of a vehicle 100 showing another exemplary set of vehicle motion characteristics. The vehicle includes a chassis 101 operatively coupled to a plurality of wheels 150 (e.g., four wheels). According to the embodiment of FIG. 5, the vehicle has a longitudinal axis (e.g., aligned with a direction of travel) that is parallel to the x-axis. The vehicle has a vertical axis (e.g., aligned with a direction of local gravity, or perpendicular to the road surface) that is parallel to the z-axis. A vehicle heave may be a translation of the vehicle about the vertical axis, as shown by the dashed arrow. A vehicle motion characteristic may be heave damping, C_{Heave}, which represents a damping of the vehicle chassis 101 in response to heave motions. Heave damping may be affected by the application of forces with one or more actuators of an active suspension system. For example, forces countering the heave motion of the chassis 101 may increase the damping of the heave motion, affecting the heave damping. Heave damping may be associated with a comfort group of vehicle motion characteristics. In some embodiments, heave damping may have an equal priority for force allocation with pitch damping. In some embodiments, heave damping may, e.g., be prioritized over pitch stiffness for force allocation. Another vehicle motion characteristic may be heave stiffness, K_{Heave}, which represents a stiffness of the vehicle chassis 101 during a heave motion. The heave stiffness may also be influenced by the application of forces with one or more actuators of an active suspension system.

FIG. 6 is a top schematic of a vehicle 100 showing another exemplary vehicle motion characteristic. The vehicle includes a chassis 101 operatively coupled to a plurality of wheels 150 (e.g., four wheels). According to the embodiment of FIG. 6, the vehicle has a longitudinal axis (e.g., aligned with a direction of travel) that is parallel to the x-axis. A vehicle twist may be a torsion of the vehicle about the vertical axis. For example, as shown by the shaded circles, two wheels on opposite corners of the vehicle may be pulled up by an active suspension actuator and the other two are pushed down by an active suspension actuator effectively simultaneously, to alter the longitudinal and/or transverse forces on the vehicle in a way that corrects yaw or mitigates undesired yaw behavior of the vehicle. Such an application of force generates torsion on the vehicle chassis about an axis of the vehicle. A vehicle motion characteristic may be twist stiffness, K_{Twist}, which represents a stiffness of the vehicle chassis 101 in response to torsion about the longitudinal axis of the chassis. Twist stiffness may be affected by the application of forces with one or more actuators of an active suspension system. Twist stiffness may be associated with, for example, a sports performance group of vehicle motion characteristics. In some embodiments, twist stiffness may be, e.g., the lowest priority for force allocation.

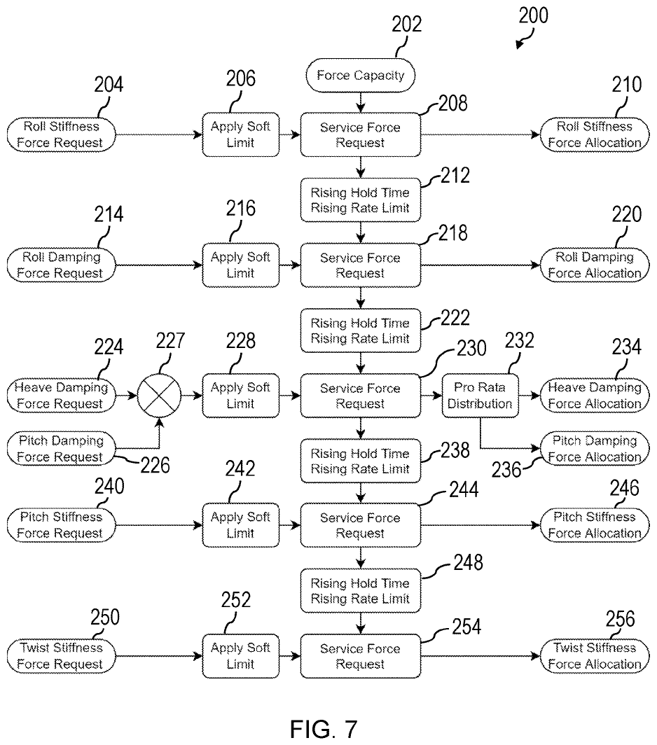

FIG. 7 is a block diagram 200 of one embodiment of a method of controlling a vehicle. The method shown in FIG. 7 may be applicable to one or more actuators of a vehicle (e.g., at least one actuator of an active suspension system). The method of FIG. 7 may incorporate information for multiple actuators of a vehicle for one or more vehicle systems, e.g., active suspension system, and command those actuators based on the determinations made according to the method. The method of FIG. 7 may provide for force allocation to control for vehicle motion characteristics according to the hierarchy of importance of vehicle motion characteristics where the actuator has a finite force capacity that may be insufficient to provide for the simultaneous control of all possible vehicle motion characteristics. In some embodiments, a force capacity as described according to the embodiment of FIG. 7 may be an average force capacity of multiple actuators of the vehicle. In this manner, the method of FIG. 7 may provide for enforcing a hierarchy of vehicle level controllers for vehicle motion characteristics or for controller commands associated with those characteristics. When a vehicle motion characteristic saturates an average force capacity of one or more actuators, the method of FIG. 7 may reduce the force allocation to the vehicle motion characteristic based on a predetermined hierarchy to each actuator based on an average scaling factor such that the scaling does not inadvertently introduce other undesirable vehicle motions or anomalies. For example, in the case of heave damping, the method may allocate force for heave damping going to each corner by the same scaling factor to ensure that undesirable pitch or roll motion are not generated. In this manner, the method of FIG. 7 may be implemented at the vehicle level, rather than at the at the actuator level to avoid applications of force that would introduce such undesirable or unintended vehicle motions.

As shown in FIG. 7, a force capacity 202 is obtained for at least one actuator. The force capacity 202 may be a maximum amount of force the at least one actuator is able to produce under a given operating condition, which may have a finite value. In some embodiments, the force capacity may be an average force capacity based on individual force capacities for each actuator of the at least one actuator. In such embodiments, individual force capacities of each actuator in a system may be obtained or determined, and then averaged to obtain the overall force capacity used for vehicle level control. In some embodiments, the force capacity may be a total force capacity (e.g., a sum) of individual force capacities for each actuator of the at least one actuator. In some embodiments, the force capacity may be received as input from a user or other source. In some embodiments, the force capacity may be determined at least partially based on a model of a particular actuator and/or information about the operating conditions of the actuator. In some embodiments, the force capacity may be at least partially based on the physical configuration of the actuator and the material limits of that configuration, if any, and accordingly may be a design force capacity. In some embodiments, the force capacity may be at least partially based on the limits of the actuator with an additional safety factor. In some embodiments, a particular actuator may have a force capacity that is at least partially based on other physical characteristics of the vehicle, such as vehicle weight, type, etc. For example, a vehicle with a greater weight may have an active suspension with a greater force capacity than a vehicle with a lower weight. In some embodiments, a particular actuator may have a force capacity that is based on empirical data collected during use of the actuator and the state of the actuator (e.g., operating temperature or degree of wear).

Once the force capacity 202 is obtained or determined, at least one processor may receive a force request from one or more controllers associated with the vehicle motion characteristics of a vehicle (e.g. chassis or vehicle body). In some embodiments, the distinct controllers may be a single processor executing an overall control scheme. In some embodiments, distinct controllers may be included on two or more processors that may communicate with one another (e.g., via a vehicle communications network). In some embodiments, two or more processors generating force requests may communicate the force requests to at least one principal processor. According to the embodiment of FIG. 7, the force requests for the various vehicle motion characteristics may be received and/or processed sequentially. That is, force may be allocated to force requests in an order or priority, with certain vehicle motion characteristics receiving force allocations for the at least one actuator before other vehicle motion characteristics. In some embodiments as shown in FIG. 7, a roll stiffness force request 204 (e.g., a first force request) may be received first. For example, in response to the roll stiffness force request, force may be allocated based on the force capacity 202. The force allocated to the roll stiffness force request may be less than or equal to the force capacity 202. In some embodiments as shown in FIG. 7, a soft limit 206 (e.g., a force allocation limit) may be applied to the force allocation to the roll stiffness force request. In some embodiments, the soft limit may be an amount of force less than the force capacity 202, such that the force allocated to the roll stiffness force request cannot equal the force capacity 202. The force allocated to the roll stiffness force request may be less than or equal to the soft limit 206. The roll stiffness is serviced in block 208 according to the roll stiffness force request, the soft limit 206, and the force capacity 202 to provide a roll stiffness force allocation 210. The roll stiffness force allocation 210 may be employed to command the at least one actuator to apply force based on the roll stiffness force allocation 210 to control the roll stiffness of the chassis. In some embodiments, the at least one actuator may apply and intervening force between the chassis of the vehicle and a wheel assembly to control the roll stiffness of the chassis based on the roll stiffness force allocation 210. As used herein, the term “force request” associated with a vehicle motion characteristic is a command provided to an actuator by a controller intended to influence the particular motion characteristic.

In some embodiments as shown in FIG. 7, a roll stiffness filter block 212 may limit a rate of increase of the roll stiffness force allocation 210 (e.g., a rising hold time) and also limit a rate of release of force allocated to the roll stiffness back to a general pool for use by other vehicle motion characteristic controllers. In some embodiments, a method of operating a vehicle may include detecting a trend of an increased force request (e.g., the roll stiffness force request 204) across a threshold period of time. According to such embodiments, detecting a positive trend in the roll stiffness force request over the threshold period of time may trigger the increase of a rising hold limit that limits the roll stiffness force allocation 210, where the roll stiffness force allocation may not exceed the rising hold limit. In some embodiments, the rising hold limit may be increased at a rate based on the force capacity 202 of the at least one actuator. In some embodiments, a rate of increase of the rising hold limit may be between 25% and 100% of the force capacity, of the at least one actuator, per second. In some embodiments, a threshold time period for detection of the trend of increased force request may be between 100 and 500 ms. It should be noted that the roll stiffness filter block 212 may be optional and not employed, in some embodiments.

In some embodiments, the roll stiffness filter block 212 may also maintain an amount of force available for the roll stiffness force request 204 and may not release force capacity for use by subsequent vehicle motion characteristic controllers. In some such embodiments, a rising rate limit (e.g., a return rate limited) of the roll stiffness filter block 212 may not allow a decrease in the roll stiffness force allocation 210 faster than the rising rate limit. In this manner, force may be allocated according to an increased rising hold limit as discussed above rather than immediately resetting to an original, lower rising hold limit even if the disturbance casing the reduced roll stiffness force request is transient. In some embodiments, the rising rate limit may be based on the force capacity 202. For example, a rising hold limit may decrease at a rate between 25% and 50% of a force capacity, of at least one actuator, per second. In some embodiments, the rising hold limit may not decrease until a threshold period of time has passed with force requests being less than the rising hold limit. In some embodiments, such a threshold period of time for the rising hold limit to being to decline is between 100 and 500 ms.

According to the embodiment of FIG. 7, once the roll stiffness force allocation 210 is determined, a roll damping force request 214 (e.g., a second force request) may be received and/or processed. The roll damping force request 214 may be second in priority to the roll stiffness force request 204. As shown in FIG. 7, a roll damping soft limit 216 may be applied to the roll stiffness force request in some embodiments. The roll stiffness soft limit may limit the amount of force that may be allocated to the roll damping force request and may be a constant limit. The roll damping force request 214 may be serviced in block 218 based on the force capacity 202, the roll stiffness force allocation 210, the roll damping soft limit 216, and the roll damping force request. The roll damping may receive a roll damping force allocation 220. In some embodiments, the roll damping force allocation 220 may be a difference between the force capacity 202 and the roll stiffness force allocation 210 up to the roll damping soft limit 216. For example, the roll stiffness force allocation may be subtracted from the force capacity to determine a remaining force capacity available for the roll damping force allocation. In this manner, the roll damping force request may be allocated the remaining force capacity of the at least one actuator allocated after the roll stiffness force allocation 210. A roll damping filter block 222 may operate similarly to the roll stiffness filter block 212. The roll damping filter block may limit the rate of increase of the roll damping force allocation, and also limit the rate of decrease of the roll damping force allocation to smooth out transient changes in the roll damping force request caused by external disturbances to the vehicle (e.g., a road event). The roll damping filter block may be optional and not employed, in some embodiments.

According to the embodiment of FIG. 7, once the roll damping force allocation 220 is determined, a heave damping force request 224 (e.g., a third force request) and a pitch damping force request 226 (e.g., a fourth force request) may be received and/or processed. In some embodiments as shown in FIG. 7, some vehicle motion characteristics may have an equal priority. Accordingly, some vehicle motion characteristics may be received and/or processed in parallel, in some embodiments. For example, in some embodiments, heave damping and pitch damping may have equal importance for control of vehicle chassis motion, such that the two force requests may be combined and then allocated according to weighting factors. The heave damping force request 224 and the pitch damping force request 226 may be combined third in priority to the roll stiffness force request 204 and the roll damping force request 214. The heave damping force request and the pitch damping force request may be combined in block 227 to form a shared force request. As shown in FIG. 7, a shared soft limit 228 may be applied to the shared force request in some embodiments. The shared soft limit may limit the amount of force that may be allocated to the shared force request and may be a constant limit. The shared force request may be serviced in block 230 based on the force capacity 202, the roll stiffness force allocation 210, the roll damping force allocation 220, the shared soft limit 228, and the shared force request. The shared force request may receive a shared force allocation that is then allocated pro rata in block 232. In some embodiments, the shared force allocation may be a difference between the force capacity 202 and the combination of the roll stiffness force allocation 210 and roll damping force allocation 220 up to the shared soft limit 228. For example, the combination of prior force allocations may be subtracted from the force capacity to determine a remaining force capacity available for the shared force allocation. In this manner, the shared force request may be allocated the remaining force capacity of the at least one actuator allocated after the roll stiffness force allocation 210 and the roll damping force allocation 220. In block 232, the shared force allocation may be divided into a heave damping force allocation 234 and a pitch damping force allocation 236. In some embodiments, the division in block 232 may be based on a weighting factor assigned to each of the force requests included in the shared force request, where each weighting factor is a percentage, and all weighting factors sum to 100%. In some embodiments, the shared force allocation may be equally split between heave damping and pitch stiffness, in which case the weighting factors for both may be 50%. In other embodiments, the shared force allocation may be split unequally according to a predetermined weighting factor. In such embodiments, a first weighting factor may be between 51 and 99%, and a second weighting factor may be between 1 and 49%. In some embodiments, more than two force requests may be received and/or processed in parallel, with a shared force allocation being distributed according to a corresponding number of weighting factors, as the present disclosure is not so limited. Additionally, in some embodiments a shared force request may include vehicle motion characteristics other than heave damping and pitch damping, as the present disclosure is not so limited.

As shown in FIG. 7, a shared filter block 238 may operate similarly to the roll stiffness filter block 212 for the shared force allocation. The shared filter block may limit the rate of increase of the shared force allocation, and also limit the rate of decease of the shared force allocation to smooth out transient changes in the roll damping force request cause by external disturbances to the vehicle (e.g., a road event). The shared filter block may be optional and not employed, in some embodiments.

According to the embodiment of FIG. 7, once the heave damping force allocation 234 and pitch damping force allocation 236 are determined, a pitch stiffness force request 240 (e.g., a fifth force request) may be received and/or processed. The pitch stiffness force request 240 may be fifth in priority to the roll stiffness force request 204, roll damping force request 214, heave damping force request 224, and pitch damping force request 226. As shown in FIG. 7, a pitch stiffness soft limit 242 may be applied to the pitch stiffness force request in some embodiments. The pitch stiffness soft limit may limit the amount of force that may be allocated to the pitch stiffness force request and may be a constant limit. The pitch stiffness force request may be serviced in block 244 based on the force capacity 202, the roll stiffness force allocation 210, the roll damping force allocation 220, the heave damping force allocation 234, the pitch damping force allocation 236, the pitch stiffness soft limit 242, and the pitch stiffness force request 240. In some embodiments, the pitch stiffness force allocation 246 may be a difference between the force capacity 202 and the combination of the roll stiffness force allocation 210, roll damping force allocation 220, heave damping force allocation 234, and pitch damping force allocation 236 up to the pitch stiffness soft limit 242. For example, the combination of prior force allocations may be subtracted from the force capacity to determine a remaining force capacity available for the pitch stiffness force allocation. In this manner, the pitch stiffness force request may be allocated the remaining force capacity of the at least one actuator allocated after the prior force allocations. As shown in FIG. 7, a pitch stiffness filter block 248 may operate similarly to the roll stiffness filter block 212 for the pitch stiffness force allocation. The pitch stiffness filter block may limit the rate of increase of the pitch stiffness force allocation, and also limit the rate of decease of the pitch stiffness force allocation to smooth out transient changes in the roll damping force request, e.g., caused by external disturbances experienced by the vehicle (e.g., a road event). The pitch stiffness filter block may be optional and not employed, in some embodiments.

According to the embodiment of FIG. 7, once the pitch stiffness force allocation 246 is determined, a twist stiffness force request 250 (e.g., a sixth force request) may be received and/or processed. The twist stiffness force request 250 may be sixth in priority to the roll stiffness force request 204, roll damping force request 214, heave damping force request 224, pitch damping force request 226, and pitch stiffness force request 250. As shown in FIG. 7, a twist stiffness soft limit 252 may be applied to the twist stiffness force request in some embodiments. The twist stiffness soft limit may limit the amount of force that may be allocated to the twist stiffness force request and may be a constant limit. The twist stiffness force request may be serviced in block 254 based on the force capacity 202, the roll stiffness force allocation 210, the roll damping force allocation 220, the heave damping force allocation 234, the pitch damping force allocation 236, the pitch stiffness force allocation 246, the twist stiffness soft limit 252, and the twist stiffness force request 250. In some embodiments, the twist stiffness force allocation 256 may be a difference between the force capacity 202 and the combination of the roll stiffness force allocation 210, roll damping force allocation 220, heave damping force allocation 234, pitch damping force allocation 236, and pitch stiffness force allocation 246 up to the twist stiffness soft limit 252. For example, the combination of prior force allocations may be subtracted from the force capacity to determine a remaining force capacity available for the twist stiffness force allocation. In this manner, the twist stiffness force request may be allocated the remaining force capacity of the at least one actuator allocated after the prior force allocations. In some embodiments, a twist stiffness filter block may operate similarly to the roll stiffness filter block 212 for the twist stiffness force allocation. The twist stiffness filter block may limit the rate of increase of the twist stiffness force allocation, and also limit the rate of decease of the twist stiffness force allocation to smooth out transient changes in the roll damping force request caused by, e.g., external disturbances experienced by the vehicle (e.g., a road event). The twist stiffness filter block may be optional and not employed, in some embodiments as shown in FIG. 7.

Once the roll stiffness force allocation 210, roll damping force allocation 220, heave damping force allocation 234, pitch damping force allocation 236, and pitch stiffness force allocation 246, and twist stiffness force allocation 256 are determined, a processor may command the at least one actuator to output force according to the force allocations. The at least one actuator may output a force interposed between a wheel assembly and the chassis of the vehicle to control the various vehicle motion characteristics based on the force allocations. In some cases, certain vehicle motion characteristics may not be controlled where the force capacity 202 of the at least one actuator is saturated or consumed by higher priority vehicle motion characteristics. In some embodiments, the process described with reference to FIG. 7 may occur cyclically. For example, force may be allocated and commanded to an at least one actuator according to a cycle rate of a vehicle control system. In some embodiments, the process described with reference to FIG. 7 may be performed for all actuators of a vehicle active suspension system based on a total force capacity of each actuator and/or an average force capacity of each actuator. In other embodiments, the process described with reference to FIG. 7 may be performed for a single actuator of a vehicle, as the present disclosure is not so limited. In some embodiments, the process described with reference to FIG. 7 may be applied to vehicle systems including actuators not forming a part of an active suspension system but affecting vehicle chassis motion, as the present disclosure is not so limited.

While in some embodiments described herein certain vehicle motion characteristics are formed in one or more groups of priority, in other embodiments vehicle motion characteristics may be grouped or otherwise ordered in any desired priority hierarchy. For example, in some embodiments, a comfort group may be prioritized over a vehicle handling group. As another example, in some embodiments, a sports performance group may be prioritized over a comfort group. In some embodiments, vehicle motion characteristics may not be grouped, and may be prioritized individual according to a desired chassis motion for a given force capacity. Any group and any priority may be employed to provide a desired chassis response when controlling chassis motion with one or more actuators having a limited force capacity, as the present disclosure is not so limited.

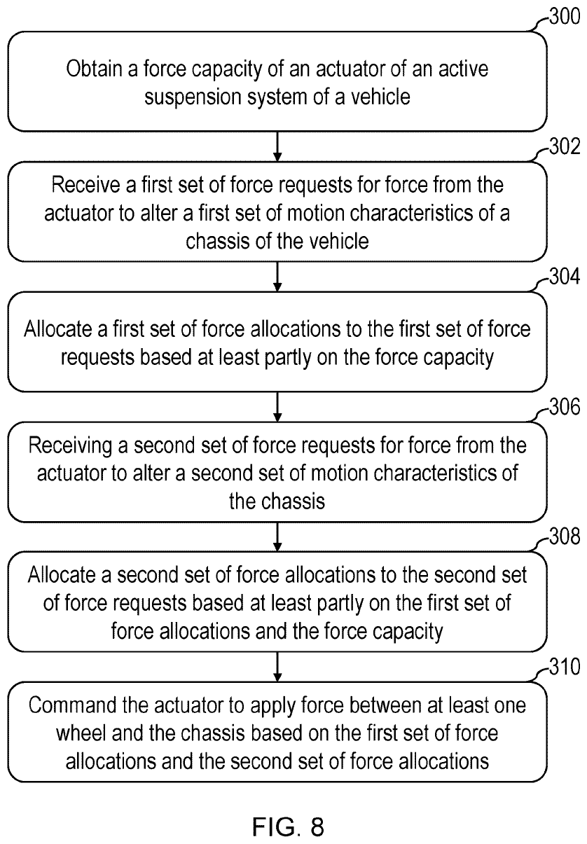

FIG. 8 is a flow chart for one embodiment of a method of controlling a vehicle. The flow chart of FIG. 8 may represent a simplified version of the method described with reference to FIG. 7, in some embodiments. In block 300, the method includes obtaining a force capacity of an actuator of an active suspension system of a vehicle. In block 302, the method includes receiving a first set of force requests for force from the actuator to alter a first set of motion characteristics of a chassis of the vehicle. In block 304, a first set of force allocations are allocated to the first set of force requests based at least partly on the force capacity of the actuator. For example, the first force allocations may not exceed the force capacity. The first set of force requests may include one or more force requests for control of one or more vehicle motion characteristic as described above. Correspondingly, the first set of force allocations may, for example, be allocated in parallel based on one or more weighting factors or in sequence according to a hierarchy. In some embodiments, the first set of force requests may include one first force request and the first set of force allocations may include one first force allocation.

As shown in FIG. 8, in block 306, the method includes receiving a second set of force requests for force from the actuator to alter a second set of motion characteristic of the chassis. The second set of vehicle motion characteristics may be different than the first set of vehicle motion characteristics, and a distinct force application in terms of magnitude and/or frequency may affect the second vehicle motion characteristics compared to the first vehicle motion characteristics. In block 308, the method includes allocating a second set of force allocations to the second force request based at least partly on the first set of force allocations and the force capacity. In some embodiments, the second force allocations may be based on a difference between the force capacity and the first force allocations, where the second force allocations do not exceed the difference. The second set of force requests may include one or more force requests for control of one or more of the second set of vehicle motion characteristics as described above. Correspondingly, the second set of force allocations may be allocated in parallel based on one or more weighting factors or in sequence according to a hierarchy. In some embodiments, the second set of force requests may include one second force request and the second set of force allocations may include one second force allocation.

As shown in FIG. 8, in block 310, the method includes commanding the actuator to apply force interposed between at least one wheel assembly and the chassis based on the first set of force allocations and the second set of force allocations. The force profile applied by the actuator in response to this command may control the first set of vehicle motion characteristics and the second set of vehicle motion characteristics in order of priority based on the first and second force allocations. For example, where the first force allocations are approximately equal to the force capacity, the actuator may apply little force, no force, or effectively no force to control the second set of vehicle motion characteristics.

The above-described embodiments of the technology described herein can be implemented in any of numerous ways. For example, the embodiments may be implemented using hardware, software, or a combination thereof. When implemented in software, the software code can be executed on any suitable processor or collection of processors, whether provided in a single computer or distributed among multiple computers. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the embodiments described herein may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present disclosure as discussed above. As used herein, the term “computer-readable storage medium” encompasses only a non-transitory computer-readable medium that can be considered to be a manufacture (i.e., article of manufacture) or a machine. Alternatively, or additionally, the disclosure may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the present disclosure as discussed above. Additionally, it should be appreciated that according to one aspect of this embodiment, one or more computer programs that when executed perform methods of the present disclosure need not reside on a single computer or processor but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present disclosure may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the embodiments described herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1-5. (canceled)

6. A vehicle comprising:
a chassis;
a plurality of wheels;
an active suspension system operatively coupled to the plurality of wheels and the chassis, wherein the active suspension system comprises at least one actuator configured to apply active forces to at least one of the plurality of wheels in at least one mode of operation; and
at least one processor configured to control the active suspension system, wherein the at least one processor is configured to:
obtain a force capacity of the at least one actuator,
receive a first force request for force from the at least one actuator to alter a first motion characteristic of the chassis,
allocate a first force allocation to the first force request based at least partly on the force capacity,
receive a second force request for force from the at least one actuator to alter a second motion characteristic of the chassis,
allocate a second force allocation to the second force request based at least partly on the first force allocation and the force capacity, and
command the at least one actuator to apply force between at least one of the plurality of wheels and the chassis based at least partly on the first force allocation and the second force allocation.

7. The vehicle of claim 6, wherein the first motion characteristic of the chassis is a roll stiffness, and wherein the second motion characteristic of the chassis is a roll damping.

8. The vehicle of claim 6, wherein the first motion characteristic of the chassis is roll stiffness or roll damping, and wherein the second motion characteristic of the chassis is heave damping or pitch damping.

9. The vehicle of claim 6, wherein the first motion characteristic of the chassis is roll stiffness or roll damping, and wherein the second motion characteristic of the chassis is pitch stiffness or twist stiffness.

10. The vehicle of claim 6, wherein the first motion characteristic of the chassis is heave damping or pitch damping, and wherein the second motion characteristic of the chassis is pitch stiffness or twist stiffness.

11. The vehicle of claim 6, wherein the at least one processor is further configured to:
receive a third force request for force from the at least one actuator to alter a third motion characteristic of the chassis; and
allocate a third force allocation to the third force request based at least partly on the first force allocation, the second force allocation and the force capacity.

12. The vehicle of claim 11, wherein allocating the second force allocation and allocating the third force allocation comprises:
determining a shared force allocation based on the force capacity and the first force allocation;
dividing the shared force allocation based on a first weighting factor to determine the second force allocation; and
dividing the shared force allocation based on a second weighting factor to determine the third force allocation.

13. The vehicle of claim 12, wherein the first weighting factor is 50%, and wherein the second weighting factor is 50% such that the second force allocation and the third force allocation are equal.

14. The vehicle of claim 13, wherein the first weighting factor is between 51 and 99%, and wherein the second weighting factor is between 1 and 49%.

15. The vehicle of claim 11, wherein the first motion characteristic of the chassis is roll stiffness or roll damping, wherein the second motion characteristic of the chassis is heave damping or pitch damping, and wherein the third motion characteristic of the chassis is pitch stiffness or twist stiffness.

16. The vehicle of claim 6, wherein the at least one processor is further configured to:
subtract the first force allocation from the force capacity to determine a first remaining force capacity, wherein allocating the second force allocation to the second force request is based at least partly on the first remaining force capacity.

17. The vehicle of claim 6, wherein the first force allocation and the second force allocation do not exceed the force capacity.

18. The vehicle of claim 6, wherein allocating the first force allocation to the first force request is based at least partly on a first allocation limit, wherein the first allocation limit is less than the force capacity, and wherein the first force allocation does not exceed the first allocation limit.

19. The vehicle of claim 18, wherein the first allocation limit is between 1 and 75% of the force capacity.

20. The vehicle of claim 6, wherein the plurality of wheels comprises a first wheel and a second wheel, wherein the at least one actuator comprises a first actuator and a second actuator, wherein the first actuator is configured to apply active forces to the first wheel in at least one mode of operation, wherein the second actuator is configured to apply active forces to the second wheel in at least one mode of operation, wherein obtaining the force capacity of the at least one actuator comprises: :
obtaining a first force capacity of the first actuator;
obtaining a second force capacity of the second actuator; and
averaging the first force capacity and the second force capacity to obtain the force capacity.

21. The vehicle of claim 20, wherein the first wheel is a front wheel of the vehicle, wherein the second wheel is a rear wheel of the vehicle.

22. The vehicle of claim 20, wherein the first wheel is a right wheel of the vehicle, wherein the second wheel is a left wheel of the vehicle.

23. A method of controlling a vehicle including a chassis, a plurality of wheels, and an active suspension system, wherein the active suspension system is operatively coupled to the plurality of wheels, and wherein the active suspension system comprises at least one actuator configured to apply active forces to at least one of the plurality of wheels in at least one mode of operation, the method comprising:
obtaining a force capacity of the at least one actuator;
receiving a first force request for force from the at least one actuator to alter a first motion characteristic of the chassis;
allocating a first force allocation to the first force request based at least partly on the force capacity;
receiving a second force request for force from the at least one actuator to alter a second motion characteristic of the chassis;
allocating a second force allocation to the second force request based at least partly on the first force allocation and the force capacity; and
commanding the at least one actuator to apply force between at least one of the plurality of wheels and the chassis based at least partly on the first force allocation and the second force allocation.

24. The method of claim 23, wherein the first motion characteristic of the chassis is a roll stiffness, and wherein the second motion characteristic of the chassis is a roll damping.

25. The method of claim 23, wherein the first motion characteristic of the chassis is roll stiffness or roll damping, and wherein the second motion characteristic of the chassis is heave damping or pitch damping.

26. The method of claim 23, wherein the first motion characteristic of the chassis is roll stiffness or roll damping, and wherein the second motion characteristic of the chassis is pitch stiffness or twist stiffness.

27. The method of claim 23, wherein the first motion characteristic of the chassis is heave damping or pitch damping, and wherein the second motion characteristic of the chassis is pitch stiffness or twist stiffness.

28. The method of claim 23, further comprising:
receiving a third force request for force from the at least one actuator to alter a third motion characteristic of the chassis; and
allocating a third force allocation to the third force request based at least partly on the first force allocation, the second force allocation and the force capacity.

29. The method of claim 28, wherein allocating the second force allocation and allocating the third force allocation comprises:
determining a shared force allocation based on the force capacity and the first force allocation;
dividing the shared force allocation based on a first weighting factor to determine the second force allocation; and
dividing the shared force allocation based on a second weighting factor to determine the third force allocation.

30. The method of claim 29, wherein the first weighting factor is 50%, and wherein the second weighting factor is 50% such that the second force allocation and the third force allocation are equal.

31. The method of claim 29, wherein the first weighting factor is between 51 and 99%, and wherein the second weighting factor is between 1 and 49%.

32. The method of claim 28, wherein the first motion characteristic of the chassis is roll stiffness or roll damping, wherein the second motion characteristic of the chassis is heave damping or pitch damping, and wherein the third motion characteristic of the chassis is pitch stiffness or twist stiffness.

33. The method of any claim 23, further comprising:
subtracting the first force allocation from the force capacity to determine a first remaining force capacity, wherein allocating the second force allocation to the second force request is based at least partly on the first remaining force capacity.

34. The method of claim 23, wherein the first force allocation and the second force allocation do not exceed the force capacity.

35. The method of claim 23, wherein allocating the first force allocation to the first force request is based at least partly on a first allocation limit, wherein the first allocation limit is less than the force capacity, and wherein the first force allocation does not exceed the first allocation limit.

36. The method of claim 35, wherein the first allocation limit is between 1 and 75% of the force capacity.

37. The method of claim 23, wherein the plurality of wheels comprises a first wheel and a second wheel, wherein the at least one actuator comprises a first actuator and a second actuator, wherein the first actuator is configured to apply active forces to the first wheel in at least one mode of operation, wherein the second actuator is configured to apply active forces to the second wheel in at least one mode of operation, wherein obtaining the force capacity of the at least one actuator comprises:
obtaining a first force capacity of the first actuator;
obtaining a second force capacity of the second actuator; and
averaging the first force capacity and the second force capacity to obtain the force capacity.

38. At least one non-transitory computer-readable medium comprising instructions thereon that, when executed by at least one processor, perform the method of claim 23.
